(19) United States
(12) Patent Application Publication
(10) Pub. No.: US 2026/0187582 A1
(43) Pub. Date: Jul. 2, 2026

(54) A METHOD AND A SYSTEM FOR AUTOMATICALLY MANAGING IN REAL-TIME DIFFERENT STABILITY TIME BUDGET PROFILES ASSIGNED TO DIFFERENT ASSETS WITHIN THE SAME SHIPMENT ENTITY

(71) Applicant: CONTROLANT HF., Kopavogur (IS)

(72) Inventors: Gisli HERJOLFSSON, Kopavogur (IS); Erlingur BRYNJULFSSON, Kopavogur (IS)

(21) Appl. No.: 19/132,134

(22) PCT Filed: Dec. 8, 2023
(86) PCT No.: PCT/EP2023/084884

§ 371 Date: May 22, 2025

(30) Foreign Application Priority Data
Dec. 8, 2022 (EP) 22212320.0

(51) Int. Cl. G06Q 10/0835; G06Q 10/083

(52) U.S. Cl. CPC G06Q 10/0835; G06Q 10/0843

(57) ABSTRACT

Aa method and a system are provided for monitoring in real-time stability time budget profile of an asset while the asset is being transported in a supply chain, includes: generating a shipment order for the asset, regularly measuring the temperature of the asset and transmitting the measured temperature to an external control computer system, where the shipment order comprises data including unique product identifier (ID) for uniquely identifying the different products and their associated stability time budget profiles; determining, by the external computer system, if the measured temperature of the asset deviates from the at least one pre-defined temperature value of the associated stability time budget profiles; and issuing, in case the remaining total stability time budget is below a pre-defined threshold value, a warning command.

### FIELD OF THE INVENTION

The present invention relates to a method a system for automatically managing in real-time different stability time budget profiles assigned to different asset within the same shipment entity.

### BACKGROUND OF THE INVENTION

Most if not all products that are used or consumed by people are associated with a stability period which may also be referred to as shelf life. Shelf life is dependent on product characteristics and is determined by product experts, commonly based on stability tests which are well defined experimental protocols.

For pharmaceutical products as an example, storage conditions are amongst others dependent on temperature, where the pharmaceutical products may have different preferred storage conditions, such as from 2-10° C., 10-20° C., or below 0° C.

One of the challenges pharmaceutical companies are dealing with today is the transport of pharmaceutical products from manufacturing facilities to end destinations of the supply chains, which may be points of consumption such as hospitals or directly to patients.

The term stability time budget profile is commonly used in relation to the transport of pharmaceutical products throughout multiple transport legs in the supply chain. The stability time budget profile is determined through numerous types of stability studies, where a stability profile for each product is established. The stability time budget profile combines relevant information from temperature studies with available data from the stability testing to determine the amount of time an asset can spend out of its labelled storage conditions without risk to its quality, safety, or efficacy. As the asset moves throughout multiple transport legs in the supply chain, the stability time budget profile is used to determine whether at the end destinations of the supply chain it's safe to be consumed, or not.

There are several challenges existing today connected to the monitoring the stability time budget. One of the drawbacks with the existing solutions is that currently the monitoring of the stability time budget is not being done in real time and complicated shipments with different pharmaceutical products with different stability time budget profiles must be manually calculated at the end destinations of the supply chain.

### SUMMARY OF THE INVENTION

It is an object of the invention to provide a fully automated solution to enhance the visibility of stability time budget profile in real-time throughout the supply chain.

In general, the invention preferably seeks to mitigate, alleviate or eliminate one or more of the above-mentioned disadvantages of the prior art singly or in any combination. In particular, it may be seen as an object of embodiments of the present invention to provide a method and a system that solves the above-mentioned problems, or other problems.

To better address one or more of these concerns, in a first aspect of the invention a method is provided of monitoring in real-time a stability time budget profile of an asset while the asset is carried by a shipment entity and transported by at least one transport means in a supply chain, comprising:
generating a shipment order for the asset,
regularly measuring the temperature of the asset and transmitting the measured temperature to an external control computer system while the asset is being transported by the shipment entity,
wherein the asset comprises two or more different product such as a pharmaceutical product having different characteristic properties, and where the shipment order comprises data including unique product identifier (ID) for uniquely identifying the different products and their associated stability time budget profiles, where each of the associated stability time budget profiles have at least one pre-defined temperature value, where the method further comprises:
determining, by the external computer system, if the measured temperature of the asset deviates from the at least one pre-defined temperature value of the associated stability time budget profiles, where for each stability time budget profile where a deviation occurs
adding together the time where the temperature deviates from the at least one pre-defined temperature value of the associated stability time budget profile,
using the added deviation time as an input parameter in determining a remaining stability time budget profile, and
issuing, in case the remaining total stability time budget is below a pre-defined threshold value, a warning command.

Accordingly, a method is provided that allows real time tracking of the stability time budget profile status for the asset throughout the supply chain.

More importantly, it is now possible to monitor in real time multiple stability time budget profiles for different pharmaceutical product that are in the same shipment entity.

The same shipment entity may as an example be same container, same pallet etc., and the two or more different pharmaceutical products carried by this shipment entity may be considered as sub-entities, e.g. boxes or other smaller packaging materials containing each of the two or more individual pharmaceutical products This may thus be understood as a tree-like structure where the shipment entity is the top of the tree like structure, and smaller sub-entities are branches from the shipment entity. This may even further extend down to sub-sub-entities, which may as an example be a carton level being smaller than the box level, which is smaller than the pallet/container level.

During the above-mentioned real time monitoring, a warning signal command may be sent early enough when the stability time budget for e.g. one of the different pharmaceutical products is reaching critical condition due to significant deviations in temperature from the at least one pre-defined temperature value, often referred to as temperature excursions.

The unique product ID may be “12345” that uniquely identifies pharmaceutical product “A” having a first stability time budget profile, and another unique product ID “78901” uniquely identifies pharmaceutical product “B” having a second stability time budget profile that may be different from the first stability time budget profile. Accordingly, the stability time budget profile for product “A” may become critical while the stability time budget profile for product “B” is not becoming critical.

The step of measuring the temperature may be done using one or more logger device(s) associated to the asset comprising a power source, a processor, a memory for storing the measured data, a transmitter, and a temperature sensor. The logger device(s) may be any type of a logger device containing any conventional batteries such as Lithium or Zink based batteries, but such logger devices are commonly 1-3 cm in thickness. The logger device(s) may be an IoT label (sometimes referred to as a smart label), which have a thickness in the millimetre range, and the like having ultrathin bendable battery. The measured data is regularly, e.g. 1 every hour, transmitted to the external control computer system that receives and processes the data, whereas the frequency of measuring may be higher, e.g. every 10 minutes the temperature is measured.

The temperature measuring may also be provided by the transport means or storage means that transports or stores the asset, e.g. containers, trucks, and warehouses where the asset is temporarily stored.

In an embodiment, the step of measuring and transmitting the measured temperature to the external control computer system is performed by a logger device associated with the asset. As an example, such a logger device may be associated to each of the sub-entities carrying the pharmaceutical products, referring to the previous example, into each individual box.

The logger device is in an embodiment uniquely identified by a logger device Identification (ID), where the logger device is further configured to transmit the logger device ID to the external computer, where the method further comprises, prior to starting the transport by the at least one transport means, pairing the unique logger device ID with the unique product ID.

In an embodiment, the step of pairing comprises:
scanning the unique product ID by a scanning device, and
storing the unique product ID in the memory of the wireless logger device, and
transmitting the stored product ID together with the unique logger device ID to the external control computer system where the paired product and logger device IDs are stored.

Referring to the above, the pairing may be done for each sub-entities individual pharmaceutical product. Such a pairing at the sub-entities level (or sub-sub entity levels) means that a logger device is associated to each pharmaceutical product by e.g. placing logger devices into each sub-entity, e.g. into each box.

The step of storing may be performed by using a Radio Frequency Identification (RFID) device that receives the scanned unique product ID and interacts with the memory of the wireless logger device resulting in said storing.

In an embodiment, the unique product ID comprises a barcode or a Quick Response (QR) code comprising at least one of a: serialization identifier, Product identifier (GTIN), expiration date identifier and/or Batch/Lot number identifier.

The QR code is configured to be placed on an outer side of the sub-entities via e.g. an adhesive layer, e.g. said packaging material, and where the wireless logger device is placed into the packaging material.

In addition to regularly transmitting the measured temperature to an external control computer system while the asset is being transported by the shipment entity, the logger device further transmits the logger device ID to the external control computer system. Therefore, with this pairing between the logger device ID and the unique product ID in place the external control computer system can extract the paired product ID information based on the received logger device ID and output information such as the geographical location of the product ID, and the stability budget of the product having the associated unique product ID in real time to a third party. The third party may as an example be the owner of the product and/or the logistic provider.

Accordingly, such a “unit pairing” enables full tracking down to the “unit level” when multiple products are initially transported within the supply chain as a larger package on e.g. said pallet, which at some time-point is split into smaller packaging units (e.g. at distribution centers) and down into unit level packages, e.g. said sub-entities which may be boxes, or smaller entities than boxes.

Due to the pairing of the logger device ID and having the logger devices associated to the sub-entities and the unique product ID, the external control computer, via the received logger device ID, acquires necessary data to link the received positional data for each individual logger device to the characteristic information of the product in the individual shipment units via the unique product ID and output information indicating the geographical location of the product having he associated product ID and its stability budget to a third party. Thus, a full visibility of the products'geographical location and stability budget data is provided for each individual product throughout the whole supply chain where multiple transport legs are present.

The position data may be understood as data that may be acquired e.g. via cellular triangulation to accurately determine the location of the asset, or it may also be understood as GPS data of the transport means which may as an example be utilized to determine the location of the asset.

In an embodiment, the at least one pre-defined temperature value is a single temperature value and where the deviation from the at least one pre-defined temperature value is where the measured temperature is above or below the single temperature value. Accordingly, this may e.g. be 0° C. where if the temperature is above this reference value, the stability time budget is reduced accordingly. An example of a stability time budget for a pharmaceutical product is 500 hours, meaning that during the transport from an origin location to a final destination, the temperature excursion may not exceed this number, i.e. the temperature may not be above 0° C. for more than 500 hours. Otherwise, the pharmaceutical product may not be released because it is not safe for consumption.

In another embodiment, the at least one pre-defined temperature value for the measured environmental related parameter comprises an upper temperature value and a lower temperature value, where the upper and lower temperature values define a reference temperature range, where the deviation from the at least one pre-defined temperature range is where the measured temperature is above the upper temperature value and/or below the lower temperature value of the reference temperature range.

Accordingly, the stability time budget profile for pharmaceutical product “A” may be 0° C.-10° C., whereas for pharmaceutical product “B” the stability time budget profile is the temperature range 2°C-8° C.. This means that stability studies for these two pharmaceutical products have shown that optimal storage conditions are within these ranges, and a deviation from these ranges are considered as a temperature excursion that reduces these stability time budget profiles. As an example, if the temperature is 9° C. for 100 hours during transport in the supply chain and/or during storage in a warehouse, these 100 hours will be deducted from the stability time budget profile for pharmaceutical product “B” but not from “A”.

In an embodiment, the at least one pre-defined temperature value further defines one or more secondary temperature range(s) above the upper temperature value and/or below the lower temperature value, where each of the one or more secondary temperature range(s) are provided with the maximum allowed time for the temperature to deviate from the reference temperature range,
wherein the method further comprises subtracting the time where the measured temperature deviates from the reference temperature range from the allowed time for the secondary temperature range(s) where the deviation occurs resulting in the remaining total stability time budget.

In an embodiment, at least one pre-defined temperature value comprises a maximum temperature value and/or minimum temperature value, where if the deviation exceeds the maximum temperature value or is below the minimum temperature value the asset is deemed to be unusable. Referring to the example above, it may be that the temperature of product “A” cannot be above 25° C. or below −5° C., i.e. there is no stability time budget for temperatures outside said range.

As an example, the at least one pre-defined temperature range has several ranges, including an optimal temperature range, e.g. 2° C.-+8° C. where the stability time budget profile remains the same if the temperature is within this range, and one or more secondary ranges above 8° C. and/or below 2° C., e.g. 8° C.-+15° C. and −2° C.-+2° C., and 15° C.-+25° C. where the stability time budget profile is the number of hours distributed on these secondary ranges, e.g. 300 hours is the maximum time where the temperature is allowed to be within range 8° C.-15° C. and 200 hours where the temperature is allowed to be within −2° C.-+2° C., and 150 hours where the temperature is within 15° C.-+25° C. etc. In such cases, if a temperature excursion occurs where the temperature is e.g. 150 hours within range 8° C.-+15° C. and 50 hours within 15° C.-+25° C., these numbers are extracted from the allowed budget meaning that the remaining stability time budget profile becomes 150 hours for range 8° C.-+15° C. and 100 hours for range 15° C.-+25° C. There is then said maximum temperature value and/or minimum temperature value, where if the deviation exceeds the maximum temperature value or is below the minimum temperature value the asset is deemed to be unusable. In this example, this could be the 25° C. and the −2° C. meaning that if the temperature goes below −2° C. or above 25° C., the pharmaceutical product may not be used.

In an embodiment, the method further comprises regularly measuring one or more additional environment related parameters select from:
temperature of the asset,
air pressure around the asset,
humidity of the asset
tilting angle of the asset,
shock on the asset
wherein managing in real-time the stability time budget profile assigned to the asset further includes monitoring the stability time budget profile for one or more of said environment related parameters.

The humidity may as an example be of relevance when considering the condition of the packaging of the assets, especially if the packaging is made of paper. The shock may as an example be of relevance if the packaging is made of glass, where too many shocks may result in breaking of the package.

In a second aspect of the invention, a system is provided for monitoring in real-time stability time budget profile of an asset while the asset is carried by a shipment entity and transported by at least one transport means in a supply chain, comprising:
an input device for receiving input command from a user when generating a shipment order for the asset,
an external control computer system,
a temperature sensor for regularly measuring the temperature of the asset, and
a transmitter for transmitting the measured temperature to the external control computer system while the asset is being transported by the shipment entity,
wherein the asset comprises two or more different products such as pharmaceutical products having different characteristic property, and where the shipment order comprises data including unique product identifier (ID) for uniquely identifying the different products and their associated stability time budget profiles, where each of the associated stability time budget profiles have at least one pre-defined temperature value,
wherein the external control computer system is configured to:
determine if the measured temperature of the asset deviates from the at least one pre-defined temperature value of the associated stability time budget profiles, where for each stability time budget profile where a deviation occurs,
add together the time where the temperature deviates from the at least one pre-defined temperature value of the associated stability time budget profile,
use the added deviation time as an input parameter in determining a remaining stability time budget profile, and
issue, in case the remaining total stability time budget is below a pre-defined threshold value, a warning command.

In an embodiment, the system further comprises at least one logger device configured to be associated with the asset, where the temperature sensor and the transmitter is comprised in the logger device.

The at least one transport means used in transporting the asset in the supply chain, e.g. any type of a motorized vehicle, may in one embodiment comprise the measuring device and the transmitter.

In general, the various aspects of the invention may be combined and coupled in any way possible within the scope of the invention. These and other aspects, features, and/or advantages of the invention will be apparent from and elucidated with reference to the embodiments described hereinafter.

### BRIEF DESCRIPTION OF THE DRAWINGS

Embodiments of the invention will be described, by way of example only, with reference to the drawings, in which

FIG. 1 shows a flowchart of an embodiment of a method according to the present invention,

FIG. 2 shows an example of three different pharmaceutical products “A”, “B” and “C” placed on a pallet, that may be transported with any type of vehicle, or be placed in a container, or may be stationary in a warehouse,

FIG. 3 shows different stability time budget profiles for the three products, and

FIG. 4 shows a system according to the present invention.

### DESCRIPTION OF EMBODIMENTS

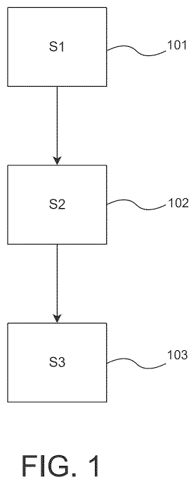

FIG. 1 shows a flowchart of an embodiment of a method according to the present invention of monitoring in real-time stability time budget profile of an asset while the asset is carried by a shipment entity and transported by at least one transport means in a supply chain.

In a first step (S1) 101 a shipment order is generated for the asset. This may as an example be performed by a shipment operator that creates the shipment in a computer device, where the shipment order may include data such as what type of asset it is, wherein the destination location of the asset etc.

In a second step (S2) 102, the temperature is regularly measured, e.g. every 10 minutes, and transmitted to an external control computer system while the asset is carried by a shipment entity and transported by at least one transport means in a supply chain. The frequency of transmission may be different from the frequency of measuring.

The device for measuring the environmental related parameter is preferably one or more logger device(s) associated to the asset, where such a logger device(s) comprises a power source, a processor, a memory for storing the measured data, a communication module comprising a transmitter, and temperature sensor. The logger device(s) may be any type of a logger device containing any conventional batteries such as Lithium or Zink based batteries.

The logger device(s) may be an IoT label (sometimes referred to as a smart label), which has a thickness in the millimetres range, and the like.

The measured data is regularly, e.g. once every hour, transmitted to the external control computer system that receives and processes the data. The measuring frequency is however typically higher, e.g. every 10 minutes, where the measured data is stored within the logger's memory unit.

The asset comprises two or more different pharmaceutical products having different characteristic property, and where the shipment order comprises data including unique product identifier (ID) for uniquely identifying the different pharmaceutical products and their associated stability time budget profiles, where each of the associated stability time budget profiles have at least one pre-defined temperature value. As an example, three different types of pharmaceutical products, each have their own stability time budget profiles, but are being transported within the same container, where one or more logger devices may be placed in the container.

In step S3 (103), it is determined, by the external computer system, if the measured temperature of the asset deviates from the at least one pre-defined temperature value of the associated stability time budget profiles. For each stability time budget profile where a deviation occurs, the following steps are performed by the external control computer system:
adding together the time where the temperature deviates from the at least one pre-defined temperature value of the associated stability time budget profile,
using the added deviation time as an input parameter in determining a remaining stability time budget profile, and
issuing, in case the remaining total stability time budget is below a pre-defined threshold value, a warning command.

The at least one pre-defined temperature value may be a single temperature value and where the deviation from the at least one pre-defined temperature value is where the measured temperature is above or below the single temperature value. An example is where the reference temperature is 2° C. where the optimal storage temperature may be below 2° C. This means that during the transport and/or storage in a warehouse, if the stability time budget profile is 500 hours, and if there is a temperature excursion where the temperature is above 2° C. for 150 hours, the remaining stability time budget becomes 350 hours.

In another embodiment, the at least one pre-defined temperature range has several ranges, including an optimal temperature range, e.g. 2° C.-+8° C. where the stability time budget profile remains the same if the temperature is within this range, and one or more secondary ranges above 8° C. and/or below 2° C., e.g. 8° C.-+15° C. and −2° C.-+2° C., and 15° C.-+25° C. where the time budget profile is the number of hours distributed on these secondary ranges, e.g. 300 hours is the maximum time where the temperature is allowed to be within range 8° C.-+15° C. and 200 hours where the temperature is allowed to be within −2° C.-+2° C., and 150 hours where the temperature is within 15° C.-+25° C. etc. In such cases, if a temperature excursion occurs where the temperature is e.g. 150 hours within range 8° C.-+15° C. and 50 hours within 15° C.-+25° C., these numbers are extracted from the allowed budget meaning that the remaining stability time budget profile becomes 150 hours for range 8° C.-+15° C. and 100 hours for range 15° C.-+25° C. There is then a maximum temperature value and/or minimum temperature value, where if the deviation exceeds the maximum temperature value or is below the minimum temperature value the asset is deemed to be unusable. In this example, this could be the 25° C. and the −2° C. meaning that if the temperature goes below −2° C. or above 25° C., the pharmaceutical product may not be used.

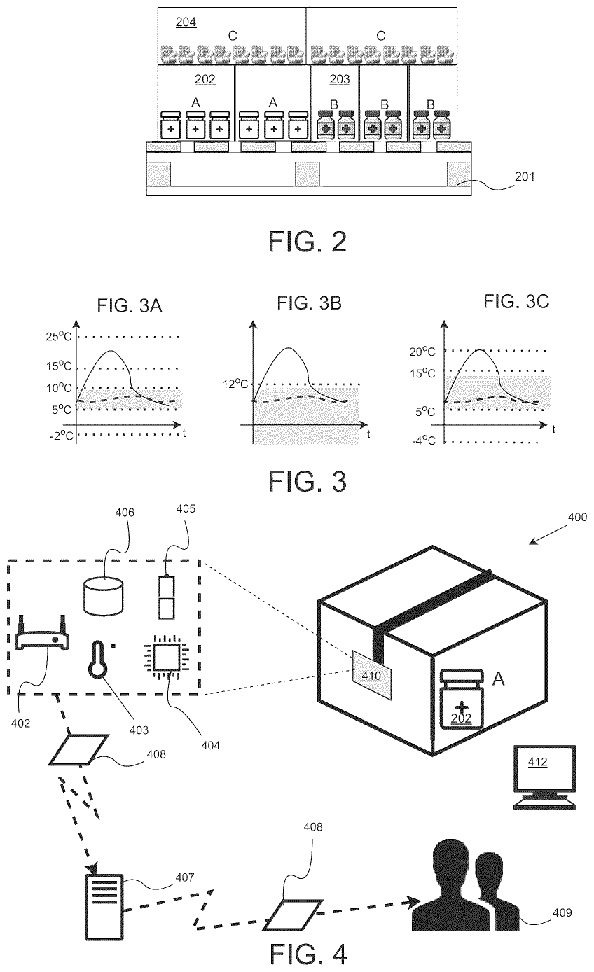

FIG. 2 shows an example of three different pharmaceutical products “A” 202, “B” 203 and “C” 204 in boxes that are placed on a pallet 201, that may be transported with any type of vehicle, or be placed in a container, or may be temporarily stationary in a warehouse.

FIG. 3 depicts graphically different stability time budget profiles for products “A” 202, “B” 203 and “C” 204, the shaded region is the optimal temperature where the stability time budget is preserved and does not change. If the temperature development as a function of time was as illustrated with the dashed line in the shaded region, the temperature time budget profile would not change for the three pharmaceutical products. However, if the temperature development as a function of time was as shown with the solid line which goes above the shaded region for some time as shown, then the stability time budget profile would change as discussed previously for all the pharmaceutical products “A” 202, “B” 203 and “C” 204.

FIG. 4 shows a system 400 for monitoring in real-time a stability time budget profile of an asset, in this case the pharmaceutical product “A” 202 which is in a box, while the product is transported in a supply chain, e.g. from an origin location (could be a manufacturing facilities) to a distribution centre or a pharmacy.

The system comprises an input device 412, e.g. any type of a computer device, for receiving input command from a user when generating a shipment order for the asset.

The pharmaceutical product “A” 202 is associated with a logger device 410 for measuring the temperature of the pharmaceutical product “A”. The logger device shown here is attached to the box via an adhesive layer, but the logger device 410 may just as well be inside the box. As illustrated here, the logger device 410 is an ultra-thin IoT label (smart label) having only a few (1-5) millimetres in thickness and comprising a power source which in this case would be an ultra-thin bendable battery 405, a processor 404, a memory 406 for storing the measured data, a transmitter 402, and temperature sensor 403.

The measured data 408 is regularly, e.g. once every hour, transmitted to the external control computer system 407 that receives and processes the data as discussed previously, whereas the frequency of measuring may be higher than the transmission, e.g. every 10 minutes where the temperature is measured and stored in the memory unit 403.

The data 408 preferably also contains position data indicating the geographical location of the asset 202. The position data may be understood as data that may be acquired e.g. via cellular triangulation to accurately determine the location of the asset, or it may also be understood as GPS data of the transport means which may as an example be utilized to determine the location of the asset.

While the invention has been illustrated and described in detail in the drawings and foregoing description, such illustration and description are to be considered illustrative or exemplary and not restrictive; the invention is not limited to the disclosed embodiments. Other variations to the disclosed embodiments can be understood and effected by those skilled in the art of practicing the claimed invention, from a study of the drawings, the disclosure, and the appended claims. In the claims, the word “comprising” does not exclude other elements or steps, and the indefinite article “a” or “an” does not exclude a plurality. The mere fact that certain measures are recited in mutually different dependent claims does not indicate that a combination of these measures cannot be used to advantage.

1.-15. (canceled)

16. A method of monitoring in real-time a stability time budget profile of an asset while the asset is carried by a shipment entity and transported by at least one transport means in a supply chain, comprising:
generating a shipment order for the asset,
regularly measuring the temperature of the asset and transmitting the measured temperature to an external control computer system while the asset is being transported by the shipment entity,
wherein the asset comprises two or more different products such as pharmaceutical products having different characteristic property, and where the shipment order comprises data including unique product identifier (ID) for uniquely identifying the different products and their associated stability time budget profiles, where each of the associated stability time budget profiles have at least one pre-defined temperature value, where the method further comprises:
determining, by the external computer system, if the measured temperature of the asset deviates from the at least one pre-defined temperature value of the associated stability time budget profiles, where for each stability time budget profile where a deviation occurs
adding together the time where the temperature deviates from the at least one pre-defined temperature value of the associated stability time budget profile,
using the added deviation time as an input parameter in determining a remaining stability time budget profile, and
issuing, in case the remaining total stability time budget is below a pre-defined threshold value, a warning command.

17. The method according to claim 16, wherein the step of measuring and transmitting the measured temperature to the external control computer system is performed by a logger device associated with the asset, where the logger device may be associated to each of the two or more different products,
wherein the logger device is uniquely identified by a logger device Identification (ID), and where the logger device is further configured to transmit the logger device ID to the external computer, where the method further comprises, prior to starting the transport by the at least one transport means, pairing the unique logger device ID with the unique product ID.

18. The method according to claim 17, wherein the step of pairing comprises:
scanning the unique product ID by a scanning device, and
storing the unique product ID in the memory of the wireless logger device, and
transmitting the stored product ID together with the unique logger device ID to the external control computer system where the paired product and logger device ID's are stored.

19. The method according to claim 16, wherein the unique product ID comprises a barcode or a Quick Response (QR) code comprising at least one of a:
serialization identifier, Product identifier (GTIN), expiration date identifier and/or Batch/Lot number identifier.

20. The method according to claim 16, wherein the two or more different products carried by this shipment entity are carried by sub-entities smaller than said entity, such as boxes, and where the QR code is placed on an outer side of the sub-entities and where such a wireless logger device is placed inside each of the sub-entities.

21. The method according to claim 16, wherein the at least one pre-defined temperature value is a single temperature value and where the deviation from the at least one pre-defined temperature value is where the measured temperature is above or below the single temperature value.

22. The method according to claim 16, wherein the at least one pre-defined temperature value for the measured environmental related parameter comprises an upper temperature value and a lower temperature value, where the upper and lower temperature values define a reference temperature range, where the deviation from the at least one pre-defined temperature range is where the measured temperature is above the upper temperature value and/or below the lower temperature value of the reference temperature range.

23. The method according to claim 22, wherein the at least one pre-defined temperature value further defines one or more secondary temperature range(s) above the upper temperature value and/or below the lower temperature value, where each of the one or more secondary temperature range(s) are provided with the uttermost allowed time for the temperature to deviate from the reference temperature range,
wherein the method further comprises subtracting the time where the measured temperature deviates from the reference temperature range from the allowed time for the secondary temperature range(s) where the deviation occurred resulting in the remaining total stability time budget.

24. The method according to claim 16, wherein the at least one pre-defined temperature value comprises a maximum temperature value and/or minimum temperature value, where if the deviation exceeds the maximum temperature value or is below the minimum temperature value the asset is deemed to be unusable.

25. The method according to claim 16, further comprising regularly measuring one or more additional environmental related parameters selected from:
temperature of the asset,
air pressure around the asset,
humidity of the asset,
tilting angle of the asset,
shock on the asset,
wherein managing in real-time the stability time budget profile assigned to the asset further includes monitoring the stability time budget profile for one or more of said environmental related parameters.

26. The method according to claim 16, further comprising transmitting the position data of the asset together with the measured temperature to the external control computer system.

27. A system for monitoring in real-time stability time budget profile of an asset while the asset is carried by a shipment entity and transported by at least one transport means in a supply chain, comprising:
an input device for receiving input command from a user when generating a shipment order for the asset,
an external control computer system,
a temperature sensor for regularly measuring the temperature of the asset, and
a transmitter for transmitting the measured temperature to the external control computer system while the asset is being transported by the shipment entity,
wherein the asset comprises two or more different products having different characteristic property, and where the shipment order comprises data including unique identifier (ID) for uniquely identifying the different products and their associated stability time budget profiles, where each of the associated stability time budget profiles have at least one pre-defined temperature value,
wherein the external control computer system is configured to:
determine if the measured temperature of the asset deviates from the at least one pre-defined temperature value of the associated stability time budget profiles, where for each stability time budget profile where a deviation occurs
add together the time where the temperature deviates from the at least one pre-defined temperature value of the associated stability time budget profile,
use the added deviation time as an input parameter in determining a remaining stability time budget profile, and
issue, in case the remaining total stability time budget is below a pre-defined threshold value, a warning command.

28. The system according to claim 27, further comprises at least one logger device configured to be associated with the asset, where the temperature sensor and the transmitter is comprised in the logger device.

29. The system according to claim 27, further comprising at least one transport means used in transporting the asset in the supply chain where the measuring device and the transmitter is comprised within the transport means.

30. The system according to claim 27, wherein the temperature sensor and the transmitter are comprised in a logger device configured to be associated with the asset, where the logger device further comprises a memory for storing the measured temperature of the asset, and a processor for controlling the temperature sensor, the transmitter and the memory.
